(19) United States
(12) Patent Application Publication
(10) Pub. No.: US 2026/0113655 A1
(43) Pub. Date: Apr. 23, 2026

(54) MOBILE COMMUNICATION TEST SYSTEM AND MOBILE COMMUNICATION TEST METHOD

(71) Applicant: ANRITSU CORPORATION, Atsugi-shi (JP)

(72) Inventors: Yutaro KANADA, Atsugi-shi (JP); Toru YAMASAKI, Atsugi-shi (JP); Shunsuke NAGASATO, Atsugi-shi (JP)

(21) Appl. No.: 19/338,322

(22) Filed: Sep. 24, 2025

(30) Foreign Application Priority Data
Oct. 18, 2024 (JP) 2024-184272

(51) Int. Cl. H04W 24/10; H04W 16/18

(52) U.S. Cl. CPC H04W 24/10; H04W 16/18

(57) ABSTRACT

A mobile communication test system has a test control unit including a setting control unit that sets a test scenario including a transmission mode defined in a layer that allows protocol testing to be performed without going through the PHY layer and RF unit; and a pseudo communication control unit that generates an IP packet with a changed format according to the set transmission mode when performing a protocol test, and controls the pseudo base station unit to transmit and receive the IP packet with the changed format between the codec processing unit and the opposing codec processing unit, and thereby the protocol test is performed without going through the PHY layer and RF unit.

### CROSS-REFERENCE TO RELATED APPLICATIONS

This application claims a priority, under the Paris Convention, to Japanese Patent Application No. 2024-184272 filed on Oct. 18, 2024, the entirety of which is incorporated herein by reference.

### TECHNICAL FIELD

The present invention relates to a mobile communication test system and a mobile communication test method that can perform tests on upper layers without implementing lower layers such as a radio signal transmission/reception unit (RF unit) or a PHY layer.

### BACKGROUND

For example, in a mobile phone system, as mobile terminals become more multifunctional, the radio communication speed with radio base stations (hereinafter referred to as base stations) is increasing, and technological development is progressing to transition from 4G (fourth generation) services that use LTE-Advanced methods to 5G (fifth generation) services (NR: New Radio). Furthermore, in recent years, in order to achieve faster and more accurate communication, the development stage is moving from 5G NR services to 6G (sixth generation) services.

In light of this background, new models of user equipment such as mobile phones (hereinafter referred to as communication terminals) are being developed one after another, but it is necessary to test whether these newly developed communication terminals operate normally. As the competition in the development of communication terminals intensifies, it is extremely important to test communication terminals inexpensively and efficiently in a short period of time.

As an example of a test device for testing a communication terminal, for example, a test device that has one or more communication units, layer processing units, and message processing units that simulate the operation of a base station, and that tests the operation of the communication functions of a communication terminal as a new communication terminal that transmits and receives radio frequency signals in accordance with a specified communication standard according to a test scenario, has been known (for example, see Patent Document 1).

### PATENT DOCUMENT

Patent Document 1: Japanese U.S. Pat. No. 5,583,726

### SUMMARY OF THE INVENTION

### Problem to be Solved by the Invention

In the test device described in Patent document 1, layer processing is performed at each level on the signal data transmitted and received between a pseudo base station and a communication terminal to be tested during testing, and the data at each level is stored as log data and displayed appropriately on the display unit. In this way, the test device described in Patent document 1, like other general conventional mobile communication device test systems, processes communication and signal data for testing the communication terminal through RF signals transmitted and received between the RF unit of the pseudo base station and the RF unit of the communication terminal.

On the other hand, in the midst of the fierce technological development competition for communication terminals as described above, many vendors are moving to shift-left in the development process to reduce development costs, and as an effective measure to achieve this, there is an increasing demand for testing upper layers without implementing lower layers such as the RF module or PHY layer.

However, this type of conventional mobile communication test system generally performs tests through the RF unit between a pseudo base station and a communication terminal, and no consideration has been given to the technology that realizes the test process for “rapidly testing upper layers without implementing lower layers,”which has been attracting attention in recent years.

For this reason, in conventional mobile communication test systems, when testing a mobile terminal, it is necessary to perform layer processing up to the PHY layer and then transmit and receive the signal data after layer processing through the RF unit. This creates an obstacle to the shift-left of the development process described above, which results in problems such as longer development times and higher development costs.

The present invention has been made to solve these conventional problems, and aims to provide a mobile communication test system and a mobile communication test method that can promote the shift-left of the development process for new user equipment, shorten the development time for upper layers, and suppress development costs.

### Means for Solving the Problem

In order to solve the above problems, the mobile communication test system related to claim 1 of the present invention comprises: a pseudo base station unit (10) comprising a layer processing unit (12) performing hierarchical processing based on a mobile communication standard including multi-RAT, a codec processing unit (13) encoding or decoding DL information and UL information to transmit and receive IP packets (7), and a scenario processing unit (11) controlling the layer processing unit and the codec processing unit; a user equipment unit (30) comprising an opposing layer processing unit (32) performing hierarchical processing based on the same communication standard as the layer processing unit, an opposing codec processing unit (33) opposing the codec processing unit to transmit and receive the DL information and the UL information, and a terminal processing unit (31) controlling the opposing layer processing unit; and a test control unit (50) controlling the pseudo base station unit and the user equipment unit according to a test scenario, wherein the mobile communication test system is adapted to perform a protocol test of the user equipment unit targeting the opposing layer processing unit, and wherein the test control unit includes: a setting control means (51) for setting a test scenario including a transmission mode defined in a layer that allows the protocol test to be performed without going through a PHY layer and an RF unit, and codec selection information corresponding to the transmission mode; and a pseudo communication control means (52) for selecting the set transmission mode and the codec selection information when the protocol test is performed according to the scenario, for generating, in accordance with the transmission mode, an IP packet whose format has been changed using a codec selected based on the codec selection information, and for controlling the pseudo base station unit to transmit and receive the IP packet whose format has been changed between the codec processing unit and the opposing codec processing unit.

With this configuration, the mobile communication test system related to claim 1 of the present invention tests upper layers such as the MAC of the user equipment unit without implementing lower layers such as the RF unit and PHY layer, which promotes a shift-left development process for new user equipment, shortens the development period for upper layers, and reduces development costs compared to when testing through the RF unit and PHY layer.

Furthermore, in the mobile communication test system related to claim 2 of the present invention, the codec processing unit and the opposing codec processing unit may be configured to alternately transmit the IP packet having System Frame information (70) and the DL information or the UL information (71) for one TTI, and perform non-real-time communication using the System Frame information as a virtual system time.

With this configuration, the mobile communication test system related to claim 2 of the present invention can pseudo-synchronize IP packets with DL information and IP packets with UL information by referencing the virtual system time, and can obtain good test results equivalent to those obtained in true real-time, despite the non-real-time timing.

In addition, in the mobile communication test system related to claim 3 of the present invention, the layer processing unit may have a first transmission mode for transmitting DL information including a MAC PDU through a MAC layer, and a second transmission mode for transmitting DL information including a PHY SDU including virtual DUT reception power, DUT reception frequency, DCI information through a PHY layer and a virtual DUT-PHY layer, the codec processing unit may be capable of changing the format of the IP packet to be transmitted and received according to the opposing codec processing unit, and the scenario processing unit may select the first transmission mode or the second transmission mode of the layer processing unit according to the test scenario, and select the format of the IP packet to be transmitted and received by the codec processing unit to perform the protocol test.

With this configuration, the mobile communication test system related to claim 3 of the present invention can select the first transmission mode and perform tests on upper layers such as the MAC layer without implementing lower layers such as the PHY layer and RF unit, and can also select the second transmission mode and verify virtual DUT reception power, DUT reception frequency, DCI information, and the like, without implementing lower layers, which can promote a shift-left development process for new user equipment.

In the mobile communication test system related to claim 4 of the present invention, the pseudo base station unit may be configured to be capable of simulating communication operations of a base station as the multi-RAT, the base station constituting each of the networks of NR standalone, LTE, LTE/NR Inter-RAT Mobility, and NR non-standalone.

With this configuration, the mobile communication test system related to claim 4 of the present invention can test upper layers such as the MAC layer for the opposing layer processing unit of the user equipment unit conforming to the communication standards of the base stations constituting each of the networks of NR standalone, LTE, LTE/NR Inter-RAT Mobility, and NR non-standalone, without implementing lower layers such as the PHY layer and RF unit, and can promote a shift-left development process for new user equipment.

To solve the above problem, the mobile communication test method related to claim 5 of the present invention is a mobile communication test method for performing a protocol test on the user equipment unit targeting the opposing layer processing unit by using the mobile communication test system described in claim 1, and comprises: a setting step (S1) of setting a test scenario including a transmission mode defined in a layer that allows the protocol test to be performed without going through a PHY layer and an RF unit, and codec selection information corresponding to the transmission mode; a step (S4) of selecting the set transmission mode and the codec selection information when performing the protocol test according to the scenario; a step (S5) of generating, in accordance with the transmission mode, an IP packet whose format has been changed using a codec selected based on the codec selection information; and a control step (S6, S7) of controlling the pseudo base station unit to transmit and receive the IP packet whose format has been changed between the codec processing unit and the opposing codec processing unit.

With this configuration, the mobile communication test method related to claim 5 of the present invention tests upper layers such as the MAC of the user equipment unit without implementing lower layers such as the RF unit and PHY layer, which promotes a shift-left in the development process of new user equipment, shortens the development period of the upper layers, and reduces development costs compared to when testing through the RF unit and PHY layer.

### Advantageous Effects of the Invention

The present invention can provide a mobile communication test system and a mobile communication test method that promote a shift-left in the development process of new user equipment, shortens the development period of the upper layers, and reduces development costs.

### BRIEF DESCRIPTION OF DRAWINGS

FIG. 1 is a block diagram showing the functional configuration of a mobile communication test system according to one embodiment of the present invention.

FIG. 2 is a diagram showing an example of the equipment configuration of a mobile communication test system according to one embodiment of the present invention.

FIG. 3 is a diagram showing another example of the equipment configuration of a mobile communication test system according to one embodiment of the present invention.

FIG. 4 is a block diagram showing an example of the functional configuration of a control device when a mobile communication test system according to one embodiment of the present invention is realized with the equipment configuration shown in FIG. 3.

FIG. 5 is a diagram showing an example of a communication interface between a pseudo base station unit and a user equipment unit (DUT) of a mobile communication test system according to one embodiment of the present invention.

FIG. 6A is a diagram showing an example of a communication sequence between a pseudo base station unit and a user equipment unit (DUT) of a mobile communication test system according to one embodiment of the present invention, showing a communication sequence for transmitting a synchronization start packet at the start of communication.

FIG. 6B is a diagram showing an example of a communication sequence between a pseudo base station unit and a user equipment unit (DUT) of a mobile communication test system according to one embodiment of the present invention, showing a communication sequence for transmitting a synchronization end packet at the end of communication.

FIG. 7 is a diagram showing a control sequence during DUT testing performed between the pseudo base station unit and the user equipment unit (DUT) of a mobile communication test system according to one embodiment of the present invention at the start and end of communication.

FIG. 8 is a diagram showing a control procedure for transmitting and receiving synchronous communication data for one TTI between a codec processing unit and an opposing codec processing unit by the control sequence shown in FIG. 7.

FIG. 9 is a diagram showing an example of the data structure of an IP packet transmitted and received between a pseudo base station unit and a user equipment unit (DUT) of a mobile communication test system according to one embodiment of the present invention.

FIG. 10 is a diagram showing a basic control sequence for the test operation of a user equipment unit in a mobile communication test system according to one embodiment of the present invention.

FIG. 11 is a diagram showing an example of a test sequence performed in step S25 of the control sequence shown in FIG. 10.

FIG. 12 is a flowchart showing the test operation control of a user equipment unit in a mobile communication test system according to one embodiment of the present invention.

FIG. 13A is a diagram for explaining the switching operation of two-system layer processing performed without going through an RF unit based on the test operation control shown in FIG. 12, showing an example of MAC-MAC layer processing.

FIG. 13B is a diagram for explaining the switching operation of two-system layer processing performed without going through an RF unit based on the test operation control shown in FIG. 12, showing an example of PHY-virtual DUT PHY layer processing.

FIG. 14 is a diagram showing the structure of the socket connection in the TE PC during DUT testing when NR pseudo base stations and LTE pseudo base stations are mixed in a mobile communication test system according to one embodiment of the present invention.

FIG. 15 is a diagram showing the transmission timing of NR packets and LTE packets during DUT testing when NR pseudo base stations and LTE pseudo base stations are mixed in a mobile communication test system according to one embodiment of the present invention.

FIG. 16 is a diagram showing the packet timing synchronization pattern of NR packets and LTE packets during DUT testing when NR pseudo base stations and LTE pseudo base stations are mixed in a mobile communication test system according to one embodiment of the present invention.

FIG. 17 is a diagram showing the control sequence during DUT testing when NR pseudo base stations and LTE pseudo base stations are mixed in a mobile communication test system according to one embodiment of the present invention.

### DETAILED DESCRIPTION OF EMBODIMENTS

The mobile communication test system according to the present invention is capable of testing a user equipment that communicates according to the NR communication standard, and has a function of simulating NR base stations and LTE base stations located in the NR and LTE areas of a non-standalone (NSA) NR network.

In addition, the mobile communication test system 1 according to the present invention may also have a function of simulating NR base stations located in NR areas of a standalone NR network (NR SA), LTE base stations located in LTE areas of a standalone LTE network (LTE SA), and NR base stations and LTE base stations located in NR and LTE areas of an LTE/NR Inter-RAT (Radio Access Technology) Mobility network.

In this way, the mobile communication test system according to the present invention is capable of testing a user equipment based on a mobile communication standard including multiple radio access technologies (multi-RAT), such as NSA (NR), NR SA, LTE SA, and LTE/NR Inter-RAT Mobility.

Hereinafter, an embodiment of the mobile communication test system and mobile communication test method according to the present invention will be described with reference to the drawings.

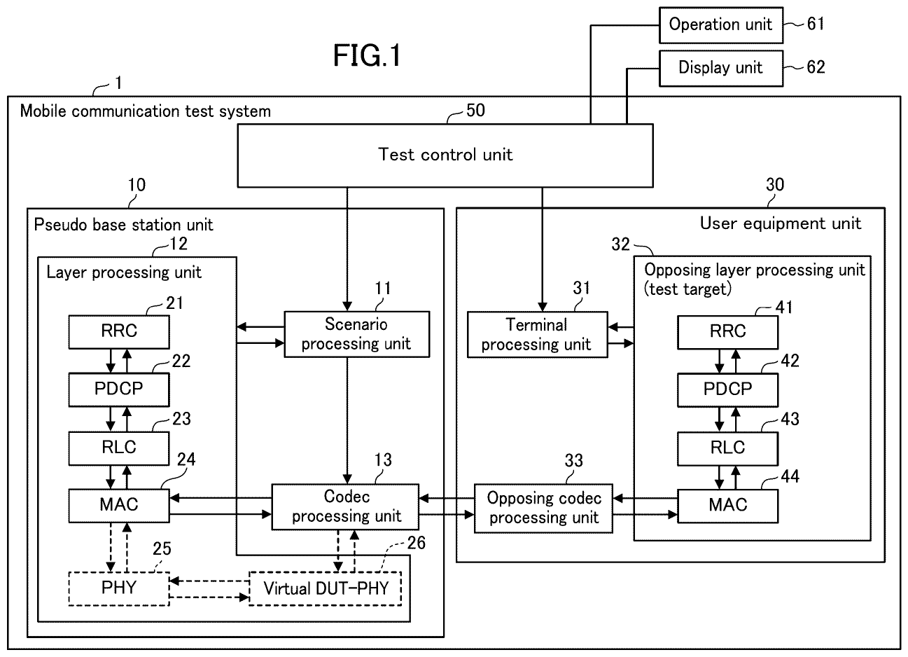

In order to realize the test function of a user equipment based on the mobile communication standard including the multi-RAT described above, the mobile communication test system 1 according to one embodiment of the present invention is roughly configured to include a pseudo base station unit 10, a user equipment unit 30, a test control unit 50, an operation unit 61, and a display unit 62, as shown in FIG. 1.

The pseudo base station unit 10 is a functional unit that performs operations as a pseudo base station opposing the user equipment unit 30 when performing a protocol test (hereinafter, sometimes simply called a test) of the user equipment unit 30 by executing a predetermined scenario, and has a scenario processing unit 11, a layer processing unit 12, and a codec processing unit 13.

The above scenario that enables the testing of the user equipment unit 30 describes a test procedure of a series of operations for simulating a communication sequence based on a communication standard (e.g., LTE standard, NR standard, and the like) predetermined in the mobile communication test system 1. In the mobile communication test system 1 according to this embodiment, the above scenario describes a test procedure of a series of operations for simulating a communication sequence based on a communication standard of multi-RAT communication (especially a communication sequence that can be implemented without going through a PHY layer or RF unit).

In the pseudo base station unit 10, the scenario processing unit 11 controls the transmission and reception of signal data for testing the user equipment unit 30 with the user equipment unit 30 according to a scenario set based on the operation of the operation unit 61.

The layer processing unit 12 is a part that performs signal processing for each layer of signal data transmitted and received during testing of the user equipment unit 30. Specifically, the layer processing unit 12 includes an RRC (Radio Resource Control Layer) processing unit 21, a PDCP (Packet Data Convergence Protocol Layer) processing unit 22, an RLC (Radio Link Control Layer) processing unit 23, a MAC (Medium Access Control Layer) processing unit 24, a PHY (Physical Layer) processing unit 25, and a virtual DUT-PHY processing unit 26.

The layer processing unit 12 performs signal processing of the RRC layer, PDCP layer, RLC layer, and MAC layer, or signal processing of the RRC layer, PDCP layer, RLC layer, MAC layer, PHY layer, and virtual DUT-PHY layer for signal data transmitted to and received from the user equipment unit 30 during testing of the user equipment unit 30. To enable this signal processing, the layer processing unit 12 has a structure that can selectively switch between two transmission modes as a signal path (transmission mode) with the codec processing unit 13: a first transmission mode that passes through the MAC processing unit 24 to the codec processing unit 13, and a second transmission mode that passes from the MAC processing unit 24 to the codec processing unit 13 through the PHY processing unit 25 and the virtual DUT-PHY processing unit 26.

The codec processing unit 13 functions as a transmitting/receiving unit that transmits and receives the above signal data when testing the user equipment unit 30, and has a function of encoding the signal data from the pseudo base station unit 10 and transmitting it to the user equipment unit 30, and a function of receiving and decoding the encoded signal data from the user equipment unit 30.

The characteristic configuration of the mobile communication test system 1 according to this embodiment is that the codec processing unit 13 transmits and receives signal data for testing between the user equipment unit 30 in a signal format of the MAC layer. Furthermore, the codec processing unit 13 has a first transmission mode in which it is directly connected to the MAC processing unit 24, and a second signal mode in which it is connected to the MAC processing unit 24 through the PHY processing unit 25 and the virtual DUT-PHY processing unit 26, as a signal mode between the codec processing unit 13 and the layer processing unit 12.

The user equipment unit 30 is the object (DUT: Device Under Test) to be tested by the mobile communication test system 1, and is a functional unit that performs the transmission and reception operation (test operation) of signal data as the opposing station of the pseudo base station unit 10 according to the above scenario during the test. The user equipment unit 30 is not limited to a configuration in which a physical machine (the user equipment itself) is arranged as shown in FIG. 1, but may be configured by software that realizes the function of the physical machine instead of the physical machine.

The user equipment unit 30 has a terminal processing unit 31, an opposing layer processing unit 32, and an opposing codec processing unit 33. The terminal processing unit 31 controls the operation of the user equipment unit 30 so that the signal data for the above test is transmitted and received with the pseudo base station in accordance with the operation of the pseudo base station according to the scenario set based on the operation of the operation unit 61.

The opposing layer processing unit 32 processes signals of each layer for signal data transmitted and received between the user equipment unit 30 and the pseudo base station during the test. Specifically, the opposing layer processing unit 32 has an RRC processing unit 41, a PDCP processing unit 42, an RLC processing unit 43, and a MAC processing unit 44, and performs signal processing of the RRC layer, the PDCP layer, the RLC layer, and the MAC layer for signal data transmitted and received between the user equipment unit 30 and the pseudo base station unit 10 during the test.

The opposing codec processing unit 33 functions as a transmission and reception unit for the signal data between the user equipment unit 30 and the pseudo base station unit 10 during the test, and has a function of decoding and receiving the encoded signal data from the pseudo base station unit 10, and a function of encoding the signal data from the user equipment unit 30 and transmitting it to the pseudo base station unit 10.

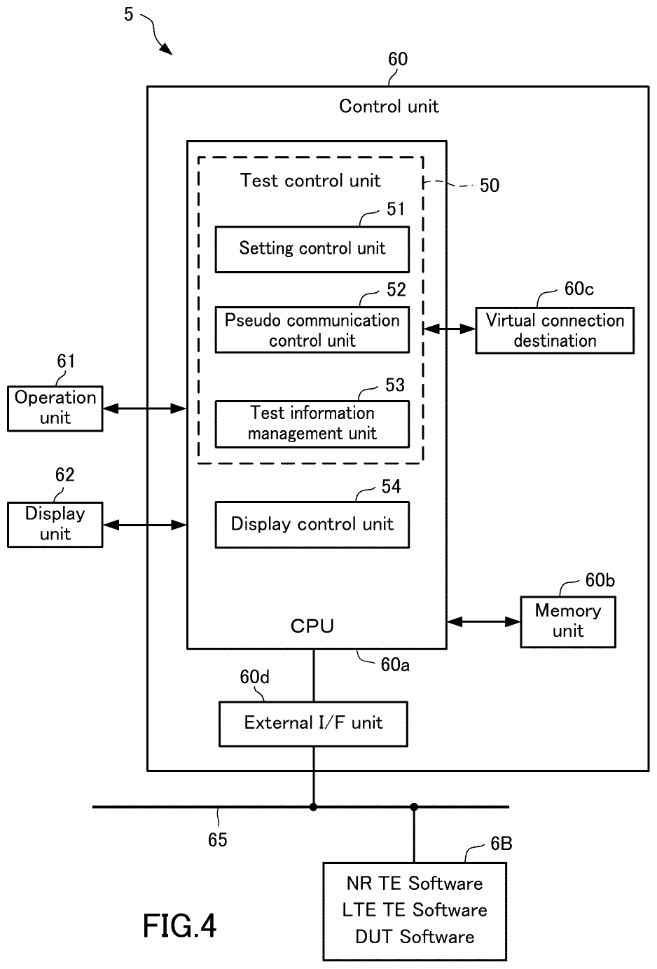

The test control unit 50 is a functional unit that comprehensively controls the pseudo base station unit 10 and each unit of the user equipment unit 30 in order to test the user equipment unit 30 according to a scenario. The configuration of the test control unit 50 will be described in detail with reference to FIG. 4.

The operation unit 61 is composed of an operation panel, such as switches and buttons. The operation unit 61 selectively performs various settings required for the communication operation test of the user equipment unit 30, including instructions to start and stop the communication operation test of the user equipment unit 30 to be tested, and settings of various information required for displaying desired information on the display unit 62.

The display unit 62 is composed of a display device such as a liquid crystal display, and displays various information, including test information such as log data obtained during the test of the user equipment unit 30.

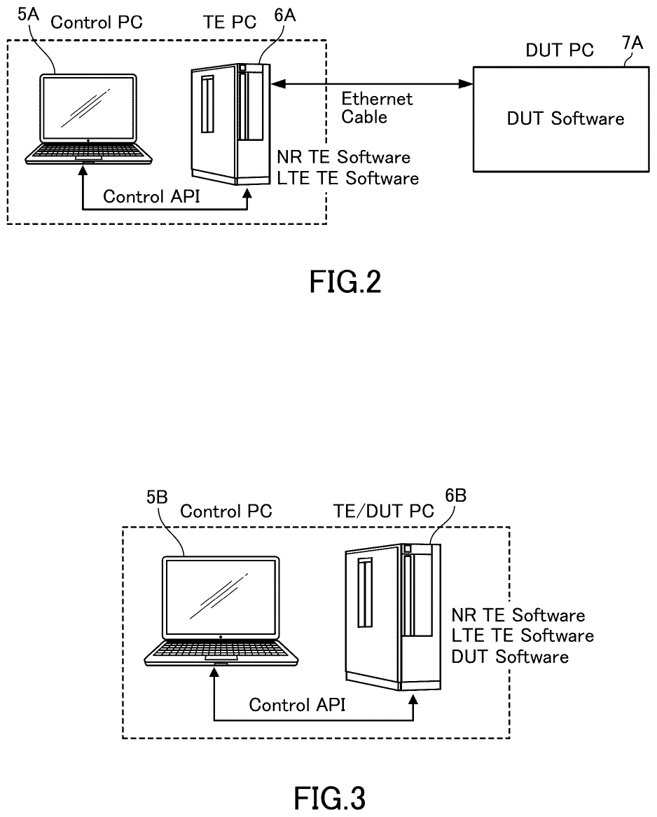

Next, the implementation of the mobile communication test system 1 (see FIG. 1) according to this embodiment will be described. As an example of the implementation of the mobile communication test system 1, a configuration such as that shown in FIG. 2, which combines multiple PCs (personal computers), is conceivable. In the configuration shown in FIG. 2, a test equipment PC (TE PC 6A) that implements software to realize the functions of the pseudo base station unit 10 and a DUT PC 7A that implements software to realize the functions of the user equipment unit 30 as a DUT are controlled from a control PC 5A. Here, the TE PC 6A and the DUT PC 7A are connected by a cable, for example, Ethernet (registered trademark), and perform TCP/IP communication. On the other hand, the TE PC 6A is controlled from the control PC 5A through a control API (Application Programming Interface) to derive the test results of the user equipment unit 30. In this configuration, the control PC 5A, TE PC 6A, and DUT PC 7A may each be a physical machine or a virtual machine.

Another possible implementation of the mobile communication test system 1 is the configuration shown in FIG. 3. In the configuration shown in FIG. 3, the TE PC 6A and DUT PC 7A shown in FIG. 2 are accommodated in the same PC (TE/DUT PC 6B) (software for implementing NR TE, LTE TE, and DUT is implemented), and the test results of the user equipment unit 30 are derived by controlling this TE/DUT PC 6B from the control PC 5B using a control API. According to this configuration, in the TE/DUT PC 6B, the TE function unit and the DUT function unit communicate through TCP/IP through a loopback connection inside the TE/DUT PC 6B.

The configuration of the mobile communication test system 1 shown in FIG. 1 can be realized, for example, by accommodating the functions of the pseudo base station unit 10 and the user equipment unit 30 in one TE/DUT PC 6B (see FIG. 3) and controlling this TE/DUT PC 6B from one control PC 5B having the function of the test control unit 50, as shown in FIG. 3. The functional configuration of the control PC 5B (hereinafter referred to as a control device 5) in this case is shown in FIG. 4.

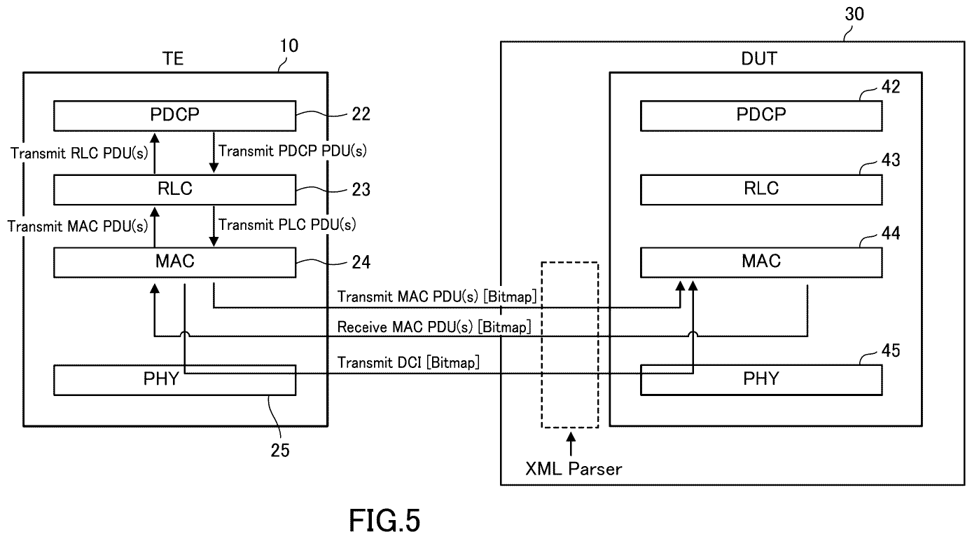

The control device 5 shown in FIG. 4 is composed of a computer device and functions as a control PC that comprehensively controls the TE/DUT PC 6B having the functions of the pseudo base station unit 10 and the user equipment unit 30. Among the components of the TE/DUT PC 6B, the functional unit having the function of the pseudo base station unit 10 and the functional unit having the function of the user equipment unit 30 are shown as the pseudo base station unit 10 and the user equipment unit 30, respectively, in FIGS. 5, 6, 7, and 13 for convenience.

As shown in FIG. 4, the control device 5 has a control unit 60, an operation unit 61, and a display unit 62. The control unit 60 has a CPU 60a, a memory unit 60b, a virtual connection destination 60c, and an external interface (I/F) unit 60d. The CPU 60a, for example, realizes the test control unit 50 by executing a program stored in the memory unit 60b.

The test control unit 50 is a functional unit that comprehensively controls the pseudo base station unit 10 and the user equipment unit 30 in order to test the user equipment unit 30 according to a scenario. The test control unit 50 is configured with a setting control unit 51, a pseudo-communication control unit 52, a test information management unit 53, and a display control unit 54. The setting control unit 51 and the pseudo-communication control unit 52 correspond to the setting control means and the pseudo-communication control means of the present invention, respectively.

The setting control unit 51 performs various setting processes such as setting a scenario (including the base station to be simulated for the pseudo-communication) for testing the user equipment unit 30 based on a predetermined setting operation in the operation unit 61, and setting simulation parameters.

The pseudo-communication control unit 52 executes a pseudo-communication operation that simulates communication between the NR base station and the LTE base station (base station information previously set as the virtual connection destination 60c) that are previously set as a combination for performing pseudo-communication according to the above-mentioned scenario, and the user equipment unit 30 to be measured, according to the simulation parameters.

The test information management unit 53 is a functional unit that acquires signal data transmitted and received between, for example, an NR base station and an LTE base station and the user equipment unit 30 during the pseudo communication operation (test), judges whether the user equipment unit 30 operates normally, and manages the test results based on the judgment result.

The display control unit 54 is a functional unit that controls the display of various information on the display unit 62, including test information such as log data obtained during the test of the user equipment unit 30. As an example, the display control unit 54 has a display control function that causes the display unit 62 to display test result information (information for grasping the combination of base stations performing pseudo communication, the carrier used, and the like) related to the test of the user equipment unit 30 based on the signal transmitted and received between the user equipment unit 30 and the NR base station and the LTE base station during the pseudo communication operation in association with the type of radio access technology (RAT).

Among the components of the control unit 60 in the control device 5 other than the test control unit 50, the memory unit 60b is a functional unit that stores various information such as test result information, in addition to programs for implementing the test control unit 50. The virtual connection destination 60c is information for identifying the virtual connection destination, such as an NR base station or an LTE base station, simulated by the pseudo base station unit 10 when testing the user equipment unit 30. The external interface (I/F) unit 60d performs an interface function for connecting the pseudo base station unit 10 of the TE/DUT PC 6B and the corresponding functional unit of the user equipment unit 30 through the network 65.

Next, the test operation of the user equipment unit 30 in the mobile communication test system 1 according to this embodiment will be described.

In this type of existing test system, it is common to simulate a base station and test the user equipment by transmitting and receiving signal data based on a specific communication standard (e.g., LTE or NR) between a pseudo base station and a user equipment through the RF unit.

In this regard, the mobile communication test system 1 according to this embodiment has a configuration that allows testing to be performed not through the RF unit, but through a layer upper than the PHY layer, and the test scenario is also designed to allow testing to be performed without through the PHY layer or RF unit.

As a method of testing a user equipment without through the RF unit, the mobile communication test system 1 according to this embodiment transmits and receives signal data between the pseudo base station unit 10 and the user equipment unit 30 in, for example, a signal form of the MAC layer when testing the user equipment unit 30, and does not actually transmit and receive signal data at a layer lower than the MAC layer.

### Communication Interface

In the mobile communication test system 1 according to this embodiment, the communication interface for transmitting and receiving signal data between the pseudo base station unit 10 and the user equipment unit 30 during testing will be described with reference to FIG. 5. FIG. 5 shows an example of a communication interface between the pseudo base station unit (e.g., TE) 10 and the user equipment unit 30 (DUT) of the mobile communication test system 1 according to one embodiment of the present invention.

In the mobile communication system 1 according to this embodiment, the pseudo base station unit 10 and the user equipment unit 30 (corresponding to “DUT” in FIGS. 2 and 3) are configured based on the protocol hierarchy of the 3GPP (registered trademark) (Third Generation Partnership Project) communication standard including multi-RAT. As an example of the protocol hierarchy, FIG. 5 illustrates a configuration in which the pseudo base station unit 10 and the user equipment unit 30 have a PDCP processing unit 22, an RLC processing unit 23, a MAC processing unit 24, and a PHY processing unit 25, and a PDCP processing unit 42, an RLC processing unit 43, a MAC processing unit 44, and a PHY processing unit 45, respectively.

As shown in FIG. 5, between the pseudo base station unit 10 and the user equipment unit 30, depending on the scenario settings, MAC PDU (Packet Data Unit) and DCI (Data Center Interconnection) information generated in the MAC layer are converted into packets (Packets) and transmitted and received through TCP Sockets (transport layer of TCP/IP and the like).

In addition, in the mobile communication system 1 according to this embodiment, the PHY PDU and DCI information generated in the PHY layer below the MAC layer can be converted into packets and transmitted/received through a TCP socket according to the change in scenario settings. The codec process that converts the MAC PDU and PHY SDU (Service Data Unit) into packets is included in the protocol process.

### Communication Sequence

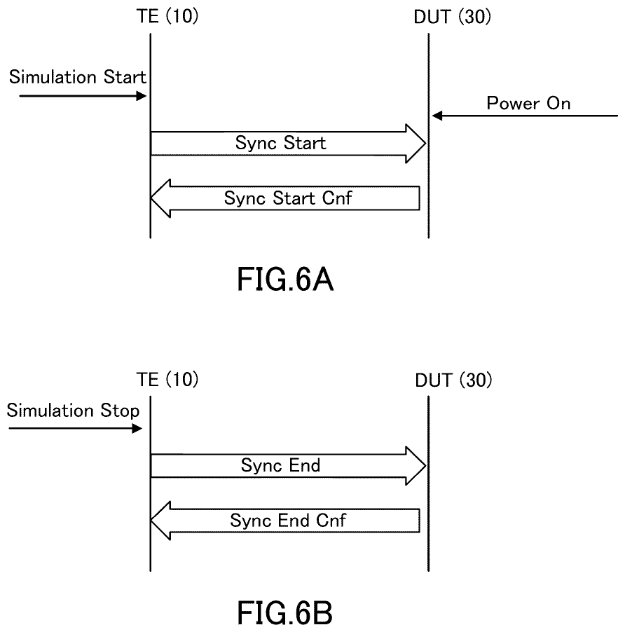

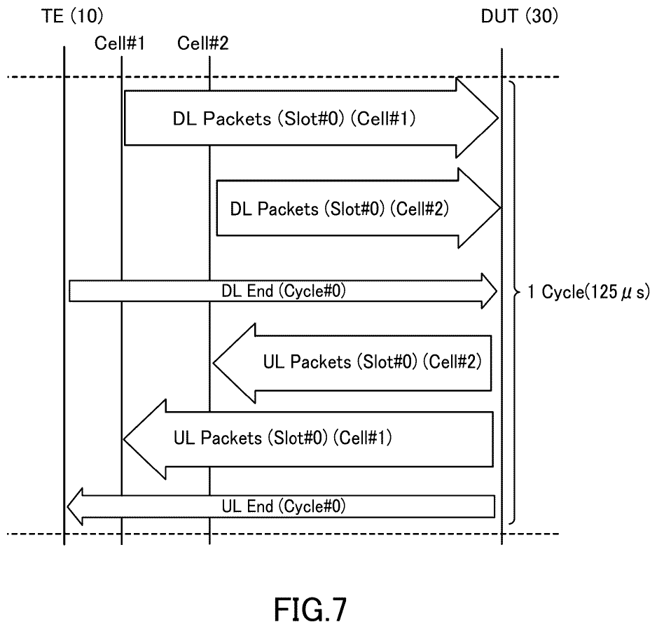

To realize the communication interface shown in FIG. 5, the mobile communication test system 1 according to this embodiment executes the communication sequence for the test shown in FIGS. 6 and 7. FIG. 6A shows the communication sequence for transmitting a synchronization start packet at the start of communication, and FIG. 6B shows the communication sequence for transmitting a synchronization end packet at the end of communication.

As shown in FIG. 6A, when starting communication for testing, the pseudo base station unit 10 is started, and after starting communication for testing, the user equipment unit 30 can be started at any timing and start communication. Here, after a TCP connection is established between the pseudo base station unit 10 and the user equipment unit 30, the pseudo base station unit 10 and the user equipment unit 30 transmit and receive the synchronization start packet (Sync Start/Sync Start Cnf) and perform handshake processing.

When the simulation is stopped, for example, as shown in FIG. 6B, the pseudo base station unit 10 and the user equipment unit 30 transmit and receive the synchronization end packet (Sync End/Syn End Cnf) and perform processing to end communication.

### Synchronous Communication

FIG. 7 shows a control sequence during DUT testing that is performed between the pseudo base station unit 10 and the user equipment unit 30 of the mobile communication test system 1 according to one embodiment of the present invention and when communication starts and ends. From the start of communication according to the communication start sequence shown in FIG. 6A until the end of communication according to the communication end sequence shown in FIG. 6B, synchronous communication according to the control sequence shown in FIG. 7 is performed between the pseudo base station unit 10 and the user equipment unit 30.

In the control sequence shown in FIG. 7, DL (Downlink) packets and UL (Uplink) packets are alternately transmitted between the pseudo base station unit 10 and the user equipment unit 30.

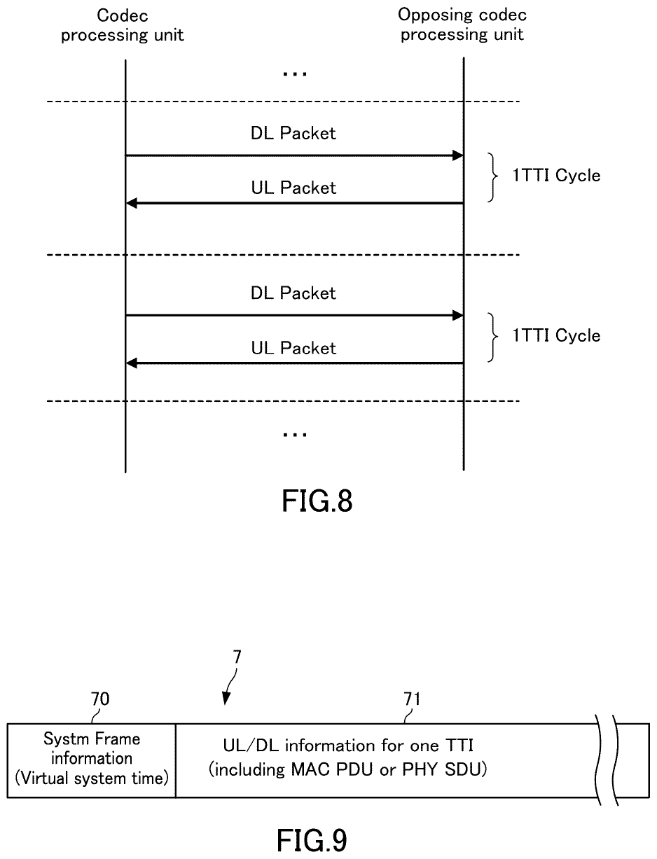

The control sequence shown in FIG. 7 transmits and receives DL packets and UL packets for each TTI between the codec processing unit 13 of the pseudo base station unit 10 and the opposing codec processing unit 33 of the user equipment unit 30, for example, according to the procedure shown in FIG. 8.

The IP packets 7, such as DL packets and UL packets, each have System Frame information (System Frame Number, Subframe Number, Slot Number) 70, as shown in FIG. 9, for example, and UL/DL information (UL information or DL information) 71 for one TTI is transmitted once or in multiple parts. The TTI (Transmission Time Interval) represents the minimum transmission period in the system. For example, NR uses ⅛ subframe, and LTE uses 1 subframe.

In this way, during testing, DL packets and UL packets are transmitted alternately every TTI, realizing non-real-time communication between the pseudo base station unit 10 and the user equipment unit 30, with the System Frame information 70 being virtual time information (see FIG. 9).

### Communication Data

Next, communication data will be explained. The format (Packet Format) of the IP packet 7 exchanged between the pseudo base station unit 10 and the user equipment unit 30 is defined according to the codec processing of the user equipment unit 30. The packet contains System Frame information 70 and UL/DL information 71 related to uplink (UL) and downlink (DL) (see FIG. 9).

In the mobile communication test system 1 according to this embodiment, the way in which the MAC PDU and PHY SDU are transmitted can be switched according to the test contents. In addition to the MAC PDU, the PHY SDU contains information such as the virtual DUT reception power, the virtual DUT reception frequency, and DCI information.

### Control of Switching of Transmission Mode

In order to enable transmission of DL packets by switching MAC PDU and PHY SDU according to the test contents, in the mobile communication test system 1 according to this embodiment, the layer processing unit 12 has a transmission mode in which DL information including MAC PDU is transmitted through the MAC processing unit 24, and a transmission mode in which DL information including PHY SDU including virtual DUT reception power, DUT reception frequency, DCI information, and the like is transmitted through the PHY processing unit 25 and the virtual DUT-PHY processing unit 26.

On the other hand, the codec processing unit 13 has a configuration capable of changing the IP packet format (Packet Format) transmitted and received according to the opposing codec unit 33 on the user equipment unit 30 side. The scenario processing unit 11 also has a control function for selecting the transmission mode of the layer processing unit 12 according to the test scenario, and for selecting the IP packet format to be transmitted and received by the codec processing unit 13 to carry out the test.

As a result, in the mobile communication test system 1 according to this embodiment, when the scenario is set in the setting control unit 51, the test control unit 50 is set in advance with codec selection information for selecting either the first transmission mode or the second transmission mode and the codec corresponding to that transmission mode, and under the control of the pseudo communication control unit 52, the scenario processing unit 11, layer processing unit 12, and codec processing unit 13 work together to enable testing with the user equipment unit 30 without going through the PHY layer and RF unit.

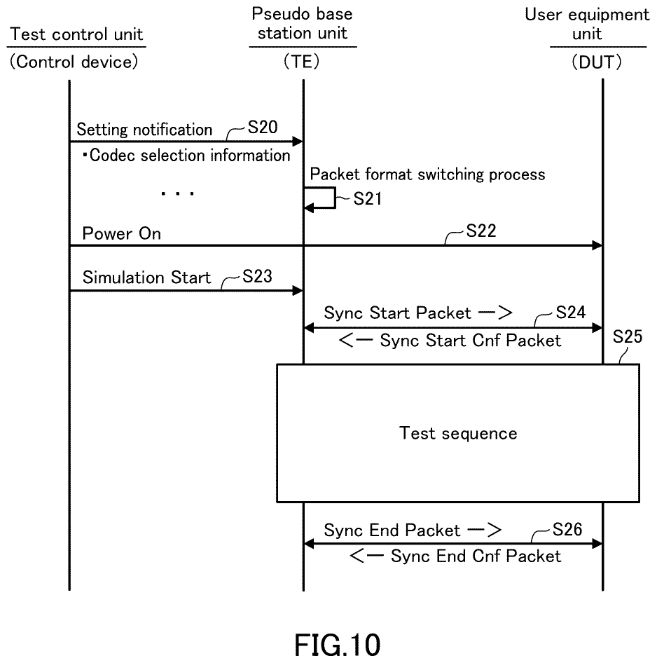

The control sequence for the test operation of the user equipment unit 30 in the mobile communication test system 1 according to this embodiment having the above configuration will be described with reference to FIG. 10.

When testing the user equipment unit 30 in the mobile communication test system 1 according to this embodiment, it is necessary to set a scenario that enables a protocol test without going through the PHY layer and RF unit. In this case, the scenario must include, for example, a transmission mode defined by a layer that allows a protocol test without going through the PHY layer and RF unit, and codec selection information for selecting a codec corresponding to that transmission mode.

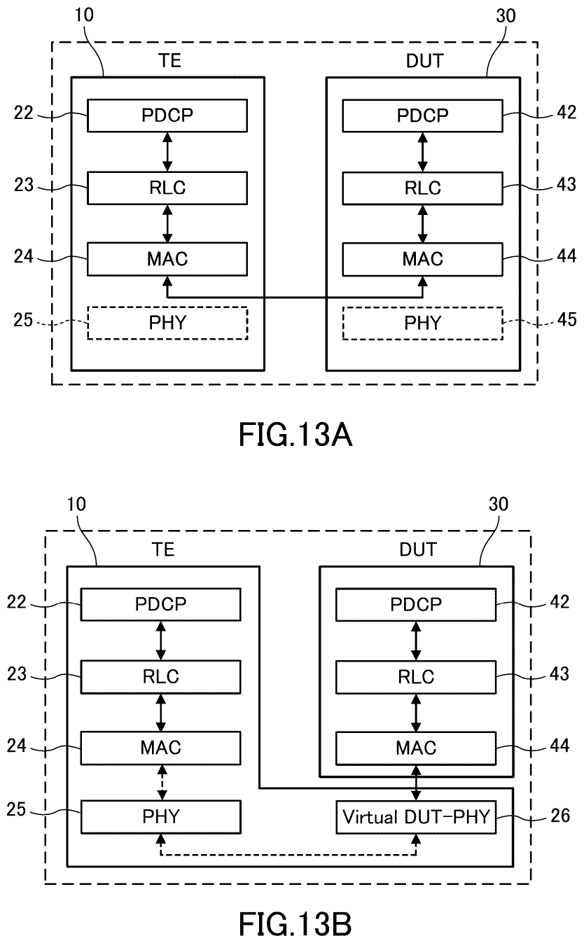

In the mobile communication test system 1 according to this embodiment, the transmission mode can be set to, for example, a first transmission mode in which IP packets 7 are exchanged between the pseudo base station unit 10 and the user equipment unit 30 by the MAC layers (see FIG. 13A), or a second transmission mode in which IP packets 7 are exchanged using the PHY layer provided in the layer processing unit 12 of the pseudo base station unit 10 and the virtual DUT-PHY layer (see FIG. 13B).

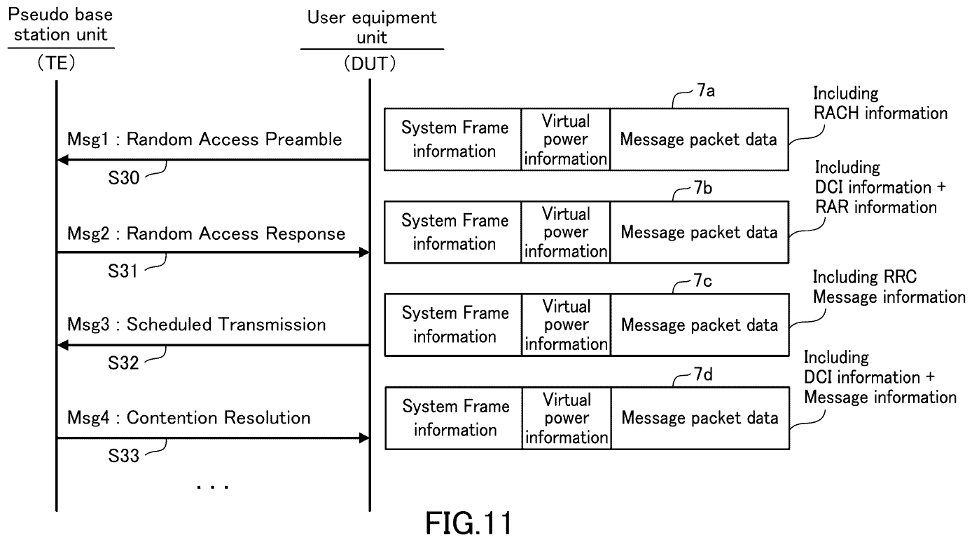

When a scenario that satisfies the above requirements is set, the mobile communication test system 1 executes test operation control according to the control sequence shown in FIG. 10. At that time, the test control unit 50 (corresponding to the “test control unit” in FIG. 10) first notifies the pseudo base station unit 10 (corresponding to the “pseudo base station unit” in FIG. 10 and FIG. 11) of the codec selection information that has been set in advance (step S20).

When the pseudo base station unit 10 receives the notification of the codec selection information, it performs a process of switching the format of the IP packets 7 (DL packets and UL packets) to be transmitted to and received from the user equipment unit 30 (corresponding to the “user equipment unit” in FIGS. 10 and 11) in the subsequent test sequence (see step S25) (step S21). The format switched at this time is one that enables layer processing according to the set transmission mode (first transmission mode or second transmission mode). Note that, although the method of switching the format of the IP packets 7 in advance before executing the test sequence has been described here, the timing of switching is not limited to this, and for example, it may be switched when the test sequence is executed.

Next, the test control unit 50 controls the user equipment unit 30 to a power-on state (step S22).

The test control unit 50 then performs a test start notification process to notify the pseudo base station unit 10 that a test is to begin (step S23).

Upon receiving the test start notification, the pseudo base station unit 10 establishes a TCP connection with the user equipment unit 30 and transmits a synchronization start packet (Sync Start Packet) to the user equipment unit 30 (step S24).

Then, the pseudo base station unit 10 performs comprehensive control of each unit to execute the test sequence (step S25). The test sequence will be described in detail with reference to FIG. 11.

When the test sequence in step S25 ends, the pseudo base station unit 10 transmits a synchronization end packet (Sync End Packet) to the user equipment unit 30 (step S26), and ends the series of control sequences related to the test of the user equipment unit 30.

An example of the test sequence (see step S25) performed in the control sequence shown in FIG. 10 is shown in FIG. 11. In particular, FIG. 11 shows an example of a RACH (Random Access Channel) procedure in which the user equipment unit 30 randomly accesses the pseudo base station unit 10 to communicate in the uplink direction (UL direction).

In the RACH procedure shown in FIG. 11, the user equipment unit 30 randomly accesses the pseudo base station unit 10, and exchanges (steps S30, S31, S32, S33) Msg1 (Random Access Preamble), Msg2 (Random Access Response), Msg3 (Scheduled Transmission), and Msg4 (Contention Resolution) procedure signals to transmit and receive control information and user data using IP packets 7a, 7b, 7c, and 7d. The IP packets 7a, 7b, 7c, and 7d contain System Frame information 70, virtual power (DUT reception power) information, message packet data, and the like. The packet data includes RACH information, DCI information and RAR information, RRC Message information, DCI information and Message information, and the like.

In the mobile communication test system 1 according to this embodiment, when, for example, a scenario in which the above-mentioned second transmission mode is specified is set in the test sequence shown in FIG. 10 (see step S25), the RACH procedure shown in FIG. 11 is performed, so that the reception power of the user equipment unit 30 can be tested through the PHY processing unit 25 and the virtual DUT-PHY processing unit 26 provided in the layer processing unit 12 of the pseudo base station unit 10 (i.e., without going through the PHY layer and RF unit).

In contrast, in the test sequence shown in FIG. 10 when a scenario in which the first transmission mode is specified is set, a communication procedure is performed in which the pseudo base station unit 10 accesses the user equipment unit 30, and the MAC layer of the user equipment unit 30 can be tested through the MAC layer-MAC layer between the pseudo base station unit 10 and the user equipment unit 30 (similarly without going through the PHY and RF unit).

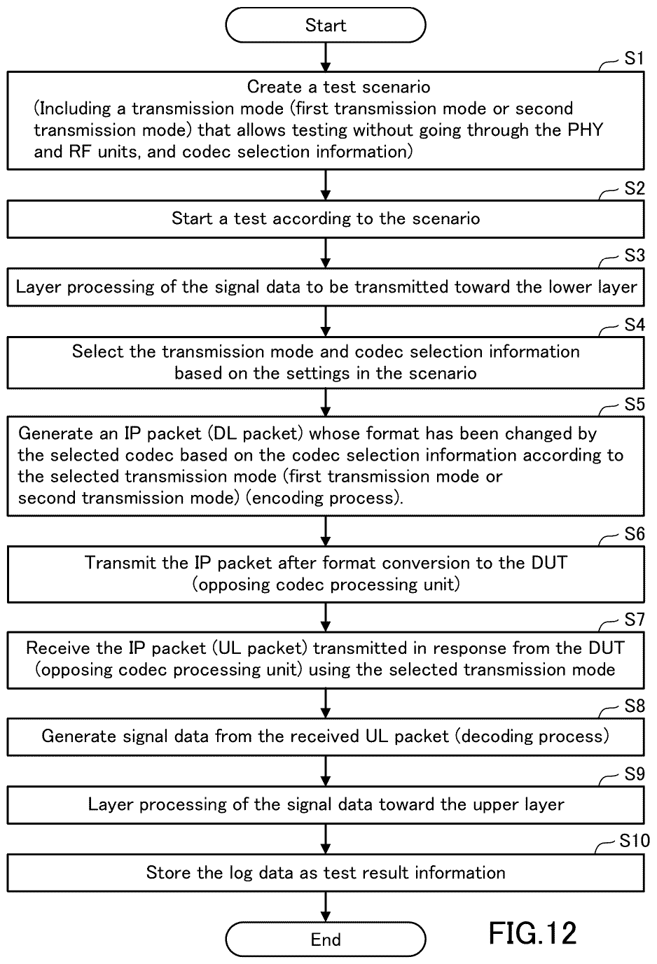

Based on the above-mentioned configuration in which the user equipment unit 30 can be tested without going through the PHY and RF unit, the test operation control of the user equipment unit 30 in the mobile communication test system 1 according to this embodiment will now be described with reference to the flowchart shown in FIG. 12.

In the mobile communication test system 1, to test the user equipment unit 30, first a scenario for the test is set (step S1). This process can be performed by inputting setting data from the operation unit 61, and the setting control unit 51 of the test control unit 50 importing the setting data to generate and register scenario data.

The scenario has a description that instructs the protocol test to be performed without going through the PHY and RF unit, and is configured to include, for example, a transmission mode defined by the layer that enables the protocol test (the layer to be verified in the protocol test) and codec selection information that selects the codec corresponding to that transmission mode.

In step S1, the setting control unit 51 sets a scenario including either a first transmission mode in which the MAC processing units 24, 44 exchange IP packets 7 between the pseudo base station unit 10 and the user equipment unit 30 (see FIG. 13A), or a second transmission mode in which the PHY processing unit 25 and the virtual DUT-PHY processing unit 26 provided in the layer processing unit 12 of the pseudo base station unit 10 exchange IP packets 7 (see FIG. 13B).

After the scenario is set, the pseudo communication control unit 52 of the test control unit 50 accepts a test start operation and starts the test operation of the user equipment unit 30 according to the scenario (step S2).

When the test operation is started, the pseudo communication control unit 52 controls the layer processing unit 12 to sequentially process the signal data in the lower layer direction in accordance with the operation of simulating a specific base station in the pseudo base station unit 10 based on the scenario (step S3).

In addition, in accordance with the start of the test, the pseudo communication control unit 52 selects a transmission mode and codec selection information based on the settings of the scenario (step S4), and controls the scenario processing unit 11, the layer processing unit 12, and the codec processing unit 13 to encode the signal data after layer processing in the layer corresponding to the above transmission mode in the layer processing unit 12 with the codec selected based on the codec selection information (the codec corresponding to the above transmission mode in the codec processing unit 13). This control generates an IP packet 7 (DL packet) whose format has been changed to match the selected transmission mode (first transmission mode or second transmission mode) (step S5).

Furthermore, the pseudo communication control unit 52 controls the transmission of the format-changed IP packet 7 (DL packet) generated by the codec processing unit 13 to the opposing codec processing unit 33 of the user equipment unit 30 on the DUT side (step S6).

Meanwhile, in the user equipment unit 30, the received IP packet 7 (DL packet) is decoded by the opposing codec processing unit 33, and the signal data obtained by this is layer-processed in the upper layer direction by the opposing layer processing unit 32 to obtain test data from the pseudo base station unit 10, and then the response signal to the test data is layer-processed in the reverse order, encoded by the opposing codec processing unit 33, and transmitted as a response to the codec processing unit 13 of the pseudo base station unit 10 as an IP packet 7 (UIP packet).

After transmitting the IP packet 7 (DL packet) to the DUT in step S5, the pseudo-communication control unit 52 receives the IP packet 7 (UL packet) transmitted in response to the IP packet 7 (DL packet) from the DUT (opposing codec processing unit 33) (step S7), and then controls the codec processing unit 13 to perform a decoding process to generate signal data from the received IP packet 7 (UL packet) (step S8).

The pseudo-communication control unit 52 then controls the layer processing unit 12 to process the decoded signal data in the layer direction, sequentially up to the uppermost layer (step S9).

The log data of the transmission and reception operations between the pseudo base station unit 10 and the user equipment unit 30 related to the series of processes from steps S3 to S9 is stored as test result information by the test information management unit 53, for example (step S10).

The series of processes from steps S3 to S10 above are performed once or multiple times per one TTL, depending on the settings.

In the test operation control of the user equipment unit 30 shown in FIG. 12, if the first transmission mode is set in the scenario, for example, in the process of step S5 above, an IP packet 7 (DL packet) including a MAC PDU is generated (see the description of “MAC PDU” in FIG. 9), and a test is performed in which the packet is transmitted and received between the pseudo base station unit 10 and the user equipment unit 30. According to this test, as shown in FIG. 13A, communication is performed between the MAC layer-MAC layer between the two, and it is possible to verify whether the MAC layer of the user equipment unit 30 is abnormal or normal without going through the PHY layer or RF unit.

In contrast, if the scenario is set to, for example, the second transmission mode, in the process of step S5 above, an IP packet 7 (DL packet) including a PHY SDU is generated (see the description of “PHY SDU” in FIG. 9), and a test is performed in which the packet is transmitted and received between the pseudo base station unit 10 and the user equipment unit 30. According to this test, as shown in FIG. 13B, for example, communication is performed between the MAC layer on the user equipment unit 30 side and the PHY layer and DUT-PHY layer virtually provided on the pseudo base station unit 10 side, and it can be determined whether the operation of the user equipment unit 30 (DUT) is correct.

By making the IP packet 7 (DL packet) at this time have a structure that includes information such as virtual DUT reception power, DUT reception frequency, and DCI information after the Frame information, it becomes possible to verify whether detailed items such as the reception power and reception frequency of the user equipment unit 30 being tested are normal or abnormal.

### Scope of Application of MAC-MAC/PHY-Virtual DUT PHY Test

The mobile communication test system 1 according to this embodiment can be applied to the MAC-MAC test (see FIG. 13A) and PHY-Virtual DUT PHY test (see FIG. 13B) of the user equipment unit 30 described above, for each of the following networks:
(i) NR SA (standalone)
(ii) LTE SA
(iii) LTE/NR Inter-RAT Mobility
(iv) NR NSA (non-standalone)

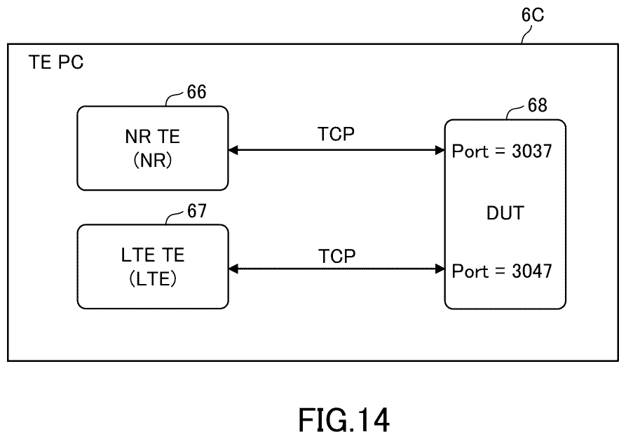

In the mobile communication test system 1 according to this embodiment, for MAC-MAC testing or PHY-virtual DUT PHY testing based on mobile communication standards including multi-RAT, it is necessary to use the same communication format as described above (see FIGS. 5 to 13) regardless of the working case (each network). In this case, in cases (iii) and (iv), it is necessary to test using a combination of cases (i) and (ii). Below, the embodiments of MAC-MAC testing and PHY-virtual DUT PHY testing in cases (iii) and (iv) are described with reference to FIGS. 14 to 17.

### Socket Connection

In the MAC-MAC test and PHY-virtual DUT PHY test in the above cases (iii) and (iv) in the mobile communication test system 1 according to this embodiment, the pseudo base station unit 10 has the function of simulating an NR base station and an LTE base station. In this way, an example of the socket connection of the control device (TE PC) 6C in the test of the DUT 68 when an NR pseudo base station (NR TE (NR)) 66 and an LTE pseudo base station (LTE TE (LTE)) 67 are mixed is shown in FIG. 14.

As shown in FIG. 14, for the socket connection in this example, the LTE TCP (Transmission Control Protocol) socket uses a different port (e.g., port 3037 and port 3047) than the NR TCP socket. The DUT opens the NR/LTE server ports separately. This configuration makes it easy to identify NR/LTE packets.

### LTE/NR Packet Transmission Timing

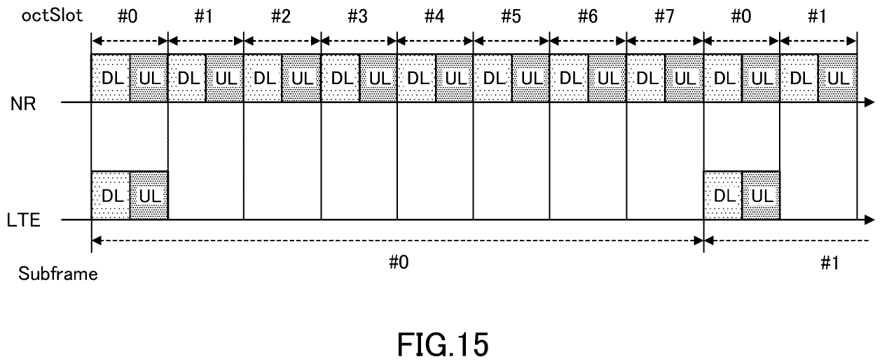

In the mobile communication test system 1 according to one embodiment of the present invention, FIG. 15 shows the transmission timing of NR packets and LTE packets when testing the DUT 68 when the NR pseudo base station 66 and the LTE pseudo base station 67 are mixed. As shown in FIG. 15, in the mobile communication test system 1 according to one embodiment of the present invention, the NR pseudo base station 66 transmits an NR packet every ⅛ subframe (#0, #1, #2, #3, #4, #5, #6, #7), while the LTE pseudo base station 67 transmits an LTE packet every subframe (#0, #1, . . . ).

### LTE/NR Packet Timing Synchronization

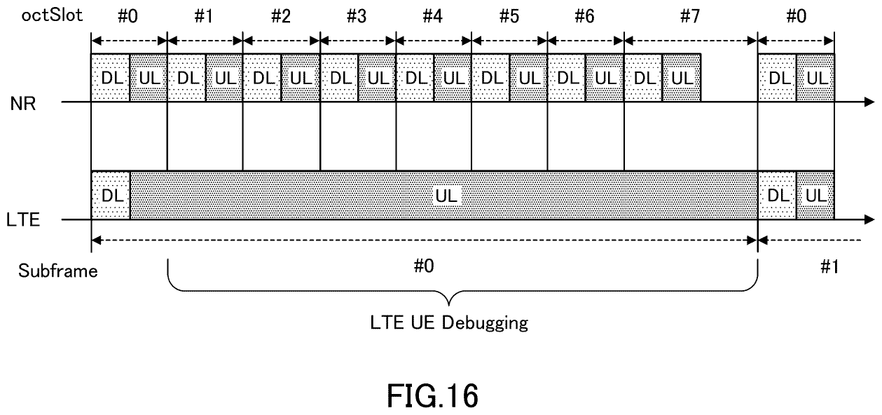

FIG. 16 shows the packet timing synchronization pattern of the NR packet and the LTE packet during the DUT testing when the NR pseudo base station 66 and the LTE pseudo base station 67 are mixed in the mobile communication test system 1 according to one embodiment of the present invention. As shown in FIG. 16, in the mobile communication test system 1 according to one embodiment of the present invention, the timing of the NR packet transmitted by the NR pseudo base station 66 and the LTE packet transmitted by the LTE pseudo base station 67 are adjusted to be synchronized at the start of each subframe. At this time, for example, if the NR packet is still being transmitted even after one subframe of the LTE packet is finished, the NR packet and the LTE packet may be adjusted to be transmitted at a synchronized timing after waiting for the NR packet to be transmitted, as shown in FIG. 16. When synchronization is completed, the NR/LTE process is executed in parallel until the next subframe starts.

### Packet Communication Sequence

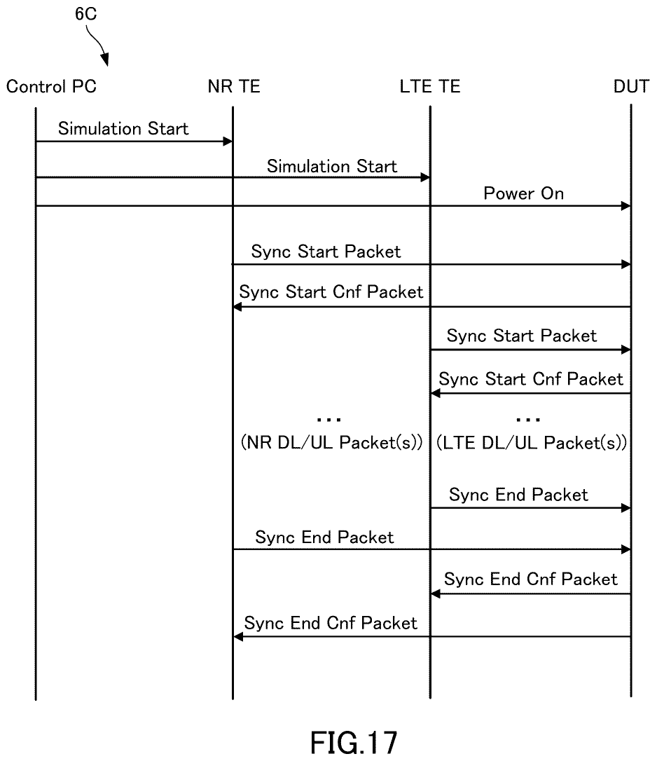

The packet communication sequence during DUT testing when the NR pseudo base station 66 and the LTE pseudo base station 67 are mixed in the mobile communication test system 1 according to one embodiment of the present invention is shown in FIG. 17. In FIG. 17, the Control PC, NR TE, LTE TE, and DET correspond to the TE PC 6C, NR pseudo base station 66, LTE pseudo base station 67, and DUT 68 in FIG. 14, respectively.

As shown in FIG. 17, in this packet communication sequence, the Control PC notifies the NR pseudo base station 66 and the LTE pseudo base station 67 of the start of the test (Simulation Start), and the DUT is controlled to be in the power-on state (Power On). After that, between the NR pseudo base station 66 and the DUT, and between the LTE pseudo base station 67 and the DUT, the test start procedure (see FIG. 6A and S24 in FIG. 10) is performed, and packet synchronous communication of NR packets and LTE packets is performed.

In this packet communication sequence, NR packets and LTE packets are transmitted in a random order. The LTE packet format has a packet payload that is specific to LTE. The NR/LTE interface is defined in separate files.

At the end of the packet communication sequence, the test termination procedure (see FIG. 6B and S26 in FIG. 10) is performed to terminate packet synchronous communication of NR packets and LTE packets.

### MAC-MAC/PHY-Virtual DUT PHY Test

In the mobile communication test system 1 according to one embodiment of the present invention, when an NR pseudo base station 66 and an LTE pseudo base station 67 are mixed, the test of the DUT 68 can be basically performed by transmitting and receiving NR/LTE packets between the NR pseudo base station 66 and the DUT 68, and between the LTE pseudo base station 67 and the DUT 68 in the manner shown in FIGS. 15 and 16, using the packet communication sequence shown in FIG. 17, using the configuration shown in FIG. 14. Even in this case, by applying the control sequence shown in FIG. 10, which includes the packet format switching process based on the codec selection information between the pseudo base station unit 10 (TE) and the user equipment unit 30 (DUT), between the NR pseudo base station 66 and the DUT 68, and between the LTE pseudo base station 67 and the DUT 68, it is possible to perform the MAC-MAC test or the MAC-virtual DUT PHY test.

In the above embodiment, the operation mode in which 5G NR and LTE are independent or mixed (see cases (i) to (iv) above) is mainly illustrated, but the present invention can also be applied to operation modes involving LTE and pre-LTE (third generation, second generation), as well as 5G NR and the next communication standard in the future.

In the above embodiment, the MAC-MAC test and the MAC-virtual DUT PHY test are given as tests that are performed without going through the RF unit, but in the present invention, as long as tests can be performed in a short time and efficiently without going through the RF unit, the layer set as the transmission mode is not limited to the MAC-MAC layer, and may be another layer. This makes it possible, for example, to perform tests by transmitting and receiving IP packets 7 at layers upper than the MAC layer, which makes it possible to further promote the shift-left in the development process of user equipment from 5G compatibility to 6G compatibility.

As described above, the mobile communication test system 1 according to this embodiment includes: a pseudo base station unit 10 including a layer processing unit 12 that performs hierarchical processing based on a communication standard including multi-RAT, a codec processing unit 13 that encodes or decodes DL information and UL information to transmit and receive an IP packet 7, a scenario processing unit 11 that controls the layer processing unit 12 and the codec processing unit 13; a user equipment unit 30 including an opposing layer processing unit 32 that performs hierarchical processing based on the same communication standard as the layer processing unit 12, an opposing codec processing unit 33 opposing the codec processing unit 13 to transmit and receive the DL information and UL information, and a terminal processing unit 31 that controls the opposing layer processing unit 32; and a test control unit 50 that controls the pseudo base station unit 10 and the user equipment unit 30 according to a test scenario, wherein the mobile communication test system is adapted to perform a protocol test of the user equipment unit 30, and wherein the test control unit 50 includes: a setting control unit 51 that sets a test scenario including a transmission mode defined in a layer that allows the protocol test to be performed without going through the PHY layer and the RF unit, and codec selection information corresponding to the transmission mode; and a pseudo communication control unit 52 that selects the set transmission mode and the codec selection information when the protocol test is performed according to the scenario, generates, in accordance with the transmission mode, an IP packet 7 whose format has been changed using a codec selected based on the codec selection information, and controls the pseudo base station unit 10 to transmit and receive the IP packet 7 whose format has been changed between the codec processing unit 13 and the opposing codec processing unit 33.

With this configuration, the mobile communication test system 1 according to this embodiment tests the upper layers such as the MAC of the user equipment unit 30 without implementing the lower layers such as the RF unit and PHY layer, which promotes a shift-left development process for new user equipment, shortens the development period for the upper layers, and reduces development costs compared to when testing through the RF unit and PHY layer.

In addition, in the mobile communication test system 1 according to this embodiment, the codec processing unit 13 and the opposing codec processing unit 33 alternately transmit IP packet 7 having System Frame information 70 and UL/DLinformation 71 for one TTI, and perform non-real-time communication using the System Frame information 70 as a virtual system time.

With this configuration, the mobile communication test system 1 according to this embodiment can pseudo-synchronize IP packets with DL information and IP packets with UL information by referencing the virtual system time, and can obtain good test results equivalent to those obtained with tests performed in true real time, despite the non-real time timing.

In addition, in the mobile communication test system 1 according to this embodiment, the layer processing unit 12 has a first transmission mode for transmitting DL information including MAC PDU through the MAC processing unit 24, and a second transmission mode for transmitting DL information including PHY SDU including virtual DUT reception power, DUT reception frequency, DCI information through the PHY processing unit 25 and the virtual DUT-PHY processing unit 26, the codec processing unit 13 is capable of changing the format of the IP packet 7 to be transmitted and received according to the opposing codec processing unit 3, and the scenario processing unit 11 selects the first transmission mode or the second transmission mode of the layer processing unit 12 according to the scenario, and selects the format of the IP packet 7 to be transmitted and received by the codec processing unit 13 to perform the protocol test. The protocol test is performed without going through the PHY layer and the RF unit.

With this configuration, the mobile communication test system 1 according to this embodiment can select the first transmission mode and perform tests on upper layers such as the MAC layer without implementing lower layers such as the PHY layer and RF unit, and can also select the second transmission mode and verify virtual DUT reception power, DUT reception frequency, DCI information, and the like, without implementing lower layers, promoting a shift-left development process for new user equipment.

In addition, in the mobile communication test system 1 according to this embodiment, the pseudo base station unit 10 is capable of simulating the communication operations of the base station as the multi-RAT, the base station constituting each of the networks including NR standalone, LTE, LTE/NR Inter-RAT Mobility, and NR non-standalone.

With this configuration, the mobile communication test system 1 according to this embodiment can test upper layers such as the MAC layer for the opposing layer processing unit 32 of the user equipment unit 30 that conforms to the communication standards of the base stations that make up each of the networks of NR standalone, LTE, LTE/NR Inter-RAT Mobility, and NR non-standalone, without implementing lower layers such as the PHY layer and RF unit, and can promote a shift-left development process for new user equipment.

The mobile communication test method according to this embodiment is a method for performing a protocol test on the user equipment unit targeting the opposing layer processing unit 32 by using the mobile communication test system 1 according to this embodiment, and includes: a setting step (S1) of setting a test scenario including a transmission mode defined in a layer that allows a protocol test to be performed without going through the PHY layer and the RF unit, and codec selection information corresponding to the transmission mode; a step (S4) of selecting the set transmission mode and codec selection information when performing a protocol test according to the scenario; a step (S5) of generating, in accordance with the transmission mode, an IP packet whose format has been changed using a codec selected based on the codec selection information; and a control step (S6, S7) of controlling the pseudo base station unit 10 to transmit and receive the IP packet 7 whose format has been changed between the codec processing unit 13 and the opposing codec processing unit 33. The protocol test is performed without going through the PHY layer and the RF unit.

With this configuration, the mobile communication test method according to this embodiment tests upper layers such as the MAC of the user equipment unit 30 without implementing lower layers such as the RF unit and PHY layer, which promotes a shift-left in the development process of new user equipment, shortens the development period of the upper layers, and reduces development costs compared to when testing through the RF unit and PHY layer.

### INDUSTRIAL APPLICABILITY

As described above, the mobile communication test system and mobile communication test method according to the present invention have the effect of promoting a shift-left in the development process of new user equipment, shortening the development period of the upper layers, and reducing development costs, and are useful for mobile communication test systems and mobile communication test methods in general that test MAC to MAC, and the like of user equipment based on mobile communication standards including multi-RAT.

### EXPLANATION OF SYMBOLS

1 Mobile communication test system
5, 6C Control device
5A, 5B Control PC
6A TE PC
6B TE/DUT PC
7, 7a, 7b, 7c, 7d IP packet
10 Pseudo base station unit
11 Scenario processing unit
12 Layer processing unit
13 Codec processing unit
21 RRC processing unit
22 PDCP processing unit
23 RLC processing unit
24 MAC processing unit
25 PHY processing unit
26 Virtual DUT-PHY processing unit
30 User equipment unit
31 Terminal processing unit
32 Opposing layer processing unit
33 Opposing codec processing unit
41 RRC Processing Unit
42 PDCP Processing Unit
43 RLC Processing Unit
44 MAC Processing Unit
50 Test Control Unit
51 Setting Control Unit (Setting Control Means)
52 Pseudo Communication Control Unit (Pseudo Communication Control Means)
53 Test Information Management Unit
54 Display Control Unit
60 Control Unit
60a CPU
60b Memory Unit
60c Virtual Connection Destination
60d External Interface (I/F) Unit
61 Operation Unit
62 Display Unit
66 NR Pseudo Base Station (NR TE)
67 LTE Pseudo Base Station (LTE TE)
68 DUT
70 System Frame Information
71 UL/DL Information

What is claimed:

1. A mobile communication test system comprising:
a pseudo base station unit (10) comprising a layer processing unit (12) performing hierarchical processing based on a mobile communication standard including multi-RAT, a codec processing unit (13) encoding or decoding DL information and UL information to transmit and receive an IP packet (7), and a scenario processing unit (11) controlling the layer processing unit and the codec processing unit;
a user equipment unit (30) comprising an opposing layer processing unit (32) performing hierarchical processing based on the same communication standard as the layer processing unit, an opposing codec processing unit (33) opposing the codec processing unit to transmit and receive the DL information and the UL information, and a terminal processing unit (31) controlling the opposing layer processing unit; and
a test control unit (50) controlling the pseudo base station unit and the user equipment unit according to a test scenario,
wherein the mobile communication test system is adapted to perform a protocol test of the user equipment unit targeting the opposing layer processing unit, and
wherein the test control unit includes:
a setting control means (51) for setting a test scenario including a transmission mode defined in a layer that allows the protocol test to be performed without going through a PHY layer and an RF unit, and codec selection information corresponding to the transmission mode; and
a pseudo communication control means (52) for selecting the set transmission mode and the codec selection information when the protocol test is performed according to the scenario, for generating, in accordance with the transmission mode, an IP packet whose format has been changed using a codec selected based on the codec selection information, and for controlling the pseudo base station unit to transmit and receive the IP packet whose format has been changed between the codec processing unit and the opposing codec processing unit.

2. The mobile communication test system according to claim 1, wherein the codec processing unit and the opposing codec processing unit alternately transmit the IP packet having System Frame information (70) and the DL information or the UL information (71) for one TTI, and perform non-real-time communication using the System Frame information as a virtual system time.

3. The mobile communication test system according to claim 1, wherein
the layer processing unit has a first transmission mode for transmitting DL information including a MAC PDU through a MAC layer, and a second transmission mode for transmitting DL information including a PHY SDU including virtual DUT reception power, DUT reception frequency, DCI information through a PHY layer and a virtual DUT-PHY layer,
the codec processing unit is capable of changing the format of the IP packet to be transmitted and received according to the opposing codec processing unit, and
the scenario processing unit selects the first transmission mode or the second transmission mode of the layer processing unit according to the test scenario, and selects the format of the IP packet to be transmitted and received by the codec processing unit to perform the protocol test.

4. The mobile communication test system according to claim 1, wherein the pseudo base station unit is capable of simulating communication operations of a base station as the multi-RAT, the base station constituting each of the networks including NR standalone, LTE, LTE/NR Inter-RAT Mobility, and NR non-standalone.

5. A mobile communication test method for performing a protocol test on the user equipment unit targeting the opposing layer processing unit by using the mobile communication test system according to claim 1, the mobile communication test method comprising:
a setting step (S1) of setting a test scenario including a transmission mode defined in a layer that allows the protocol test to be performed without going through a PHY layer and an RF unit, and codec selection information corresponding to the transmission mode;
a step (S4) of selecting the set transmission mode and the codec selection information when performing the protocol test according to the scenario;
a step (S5) of generating, in accordance with the transmission mode, an IP packet whose format has been changed using a codec selected based on the codec selection information; and
a control step (S6, S7) of controlling the pseudo base station unit to transmit and receive the IP packet whose format has been changed between the codec processing unit and the opposing codec processing unit.
